(19) United States
(12) Patent Application Publication
(10) Pub. No.: US 2022/0281696 A1
(43) Pub. Date: Sep. 8, 2022

(54) SUBSTRATE TRANSPORTING APPARATUS

(71) Applicant: CORNING INCORPORATED, CORNING, NY (US)

(72) Inventors: Nathanael Hermsdorf, München (DE); Robert Korbinian Parsiegla, Munich (DE); Joerg Reuner, Munich (DE); Michael Schaefer, Eching (DE); Florian Spaeth, Eching (DE)

(21) Appl. No.: 17/680,442

(22) Filed: Feb. 25, 2022

Related U.S. Application Data
(60) Provisional application No. 63/157,256, filed on Mar. 5, 2021.

(51) Int. Cl. B65G 49/06

(52) U.S. Cl. CPC B65G 49/061; B65G 49/064; B65G 2201/022

(57) ABSTRACT

A substrate transporting apparatus including a carrier that is configured to support a substrate to be processed. A plurality of holes are disposed within the carrier, each hole extending from a first surface to a second surface of the carrier, the plurality of holes including at least a first hole and a second hole. A first bearing device is disposed in the first hole, the first bearing device including a first shaft, a first head, and an internal opening extending an entire length of the first shaft and the first head. The second hole is either (i) is an open hole without a bearing device disposed therein, or (ii) has a second bearing device disposed therein, the second bearing device including a second shaft and a second head without an internal opening disposed through the second shaft.

This application claims the benefit of priority under 35 U.S.C. § 119 of U.S. Provisional Application Ser. No. 63/157,256 filed on Mar. 5, 2021, the content of which is relied upon and incorporated herein by reference in its entirety.

### FIELD OF THE DISCLOSURE

The present disclosure is generally directed to a substrate transporting apparatus, and more particularly relates to a substrate transporting apparatus with a plurality of bearing devices to support a substrate to be processed, along with systems and methods for operating a substrate transporting apparatus.

### BACKGROUND OF THE DISCLOSURE

Various methods and apparatuses for processing glass sheets are known. For example, conventional methods use lasers to ablate a glass sheet to form one or more cutouts from the glass sheet. The laser forms a laser beam having a wavelength that is absorbed by the glass material in order to ablate the glass. Furthermore, it is well-known to use a positioning table to support the glass sheet during such an ablation process. Positioning tables generally include a horizontal conveyor to transport the glass sheet between multiple processing locations. For example, a horizontal conveyor can transport the glass sheet through a laser processing system that ablates the glass material, a cooling device that cools the glass material after the ablation process, and a garbage disposal system that collects and removes the scrap glass material. In some conventional systems, the conveyor is moved by linear actuators in both X and Y directions while a process head with a laser, which is disposed above the conveyor, directs a laser beam onto the glass sheet for the ablation process.

During laser ablation processes, the glass sheet must be securely fastened to the conveyor. Any unintentional movement of the glass sheet relative to the conveyor could result in an imprecise or incorrect laser cut, even with very minor movements. It is known in the art to use suction to secure a glass sheet to a conveyor during a glass ablation process. Therefore, the glass sheet is suctioned to the conveyor by a vacuum force. However, any contact between the glass sheet and conveyor could scratch the glass sheet or even potentially break the glass sheet.

Therefore, there is a need to secure a glass sheet to a conveyor, for processing of the glass sheet, while preventing scratching of the glass sheet.

### SUMMARY OF THE DISCLOSURE

An exemplary approach to solve the object is described by the independent claims. Various embodiments are defined with the dependent claims.

Aspects of the present disclosure securely fasten a substrate, such as a glass sheet, to a carrier for processing of the substrate. The carrier may be a conveyor, a table, or a transport belt. Furthermore, the carrier comprises one or more bearing devices so that a gap is formed between the substrate and the carrier while the substrate is secured to the carrier. Such allows the substrate to be sufficiently anchored to the carrier but also prevents any scratching of the substrate from contact with the carrier. As discussed further below, embodiments of the present disclosure encompass bearing devices with and without a polymeric cover and bearing devices with and without an internal cavity. The internal cavity is used to provide a suction or air bearing effect to the substrate. The carrier comprises a plurality of holes, each of which may receive a bearing device. A processing unit may be used to determine which holes receive a bearing device, what kind of bearing device is received in those holes, and which holes are left open without a bearing device.

According to a first aspect, a substrate transporting apparatus is disclosed comprising a carrier having a first surface and a second surface opposite the first surface, the carrier being configured to support a substrate to be processed. A plurality of holes are disposed within the carrier, each hole extending from the first surface to the second surface of the carrier, the plurality of holes comprising at least a first hole and a second hole. Furthermore, a first bearing device is disposed in the first hole, the first bearing device comprising a first shaft, a first head, and an internal opening extending an entire length of the first shaft and the first head. And the second hole either (i) is an open hole without a bearing device disposed therein, or (ii) comprises a second bearing device disposed therein, the second bearing device comprising a second shaft and a second head without an internal opening disposed through the second shaft.

According to another aspect, a method of assembling a substrate transporting apparatus is disclosed. The method comprising the steps of receiving substrate cutting information from a substrate processing apparatus, the substrate cutting information including a cutting pathway for cutting a substrate along a predetermined pattern, and determining which holes of a plurality of holes on a carrier are disposed along the cutting pathway of the predetermined pattern. Furthermore, based upon the determination, designating one or more holes of the plurality of holes as receiving a first bearing device and designating one or more holes of the plurality of holes as either (i) not receiving a bearing device or (ii) receiving a second bearing device. The first bearing device comprises a first shaft, a first head, and an internal opening extending an entire length of the first shaft and the first head. The second bearing device comprises a second shaft and a second head without an internal opening disposed through the second shaft.

Although many different embodiments are listed, the embodiments may exist individually or in any combination as possible. Hereinafter exemplary embodiments are shown and described.

### BRIEF DESCRIPTION OF THE DRAWINGS

FIG. 1 is a schematic diagram illustrating a cross-sectional view of a carrier, according to embodiments of the present disclosure;

FIG. 2 is another schematic diagram illustrating a cross-sectional view of a carrier, according to embodiments of the present disclosure;

FIG. 3A is a schematic diagram illustrating a bearing device, according to embodiments of the present disclosure;

FIG. 3B is another schematic diagram illustrating a bearing device, according to embodiments of the present disclosure;

FIG. 3C is a schematic diagram illustrating a top view of a bearing device, according to embodiments of the present disclosure;

FIG. 3D is another schematic diagram illustrating a bearing device, according to embodiments of the present disclosure;

FIG. 3E is a schematic diagram illustrating a perspective view of a bearing device, according to embodiments of the present disclosure;

FIG. 3F is a schematic diagram illustrating a cross-sectional view of a bearing device, according to embodiments of the present disclosure;

FIG. 3G is another schematic diagram illustrating a cross-sectional view of a bearing device, according to embodiments of the present disclosure;

FIG. 4A is a schematic diagram illustrating a perspective view of a carrier, according to embodiments of the present disclosure;

FIG. 4B is a schematic diagram illustrating an enlarged portion of FIG. 4A;

FIG. 4C is a schematic diagram illustrating a cross-sectional view of a bearing device disposed in a carrier, according to embodiments of the present disclosure;

FIG. 5 is a schematic diagram illustrating a perspective view of a carrier with a plurality of cutting pathways, according to embodiments of the present disclosure; and

FIG. 6 is a schematic representation of a processing apparatus, according to embodiments of the present disclosure.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It is also important to note that the construction and arrangement of the elements of the disclosure, as shown in the exemplary embodiments, is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the desired and other exemplary embodiments without departing from the spirit of the present disclosure.

Reference will now be made in detail to the present preferred embodiments of the disclosure, examples of which are illustrated in the accompanying drawings. Whenever possible, the same reference numbers will be used throughout the drawings to refer to the same or like parts.

Referring now to FIG. 1, an exemplary transport apparatus 10 is shown in cross-sectional view, according to one example. Transport apparatus 10 comprises a carrier 20 and a plurality of holes 30 extending through carrier 20. More specifically, holes 30 each extend from a first surface 22 to a second surface 24 of carrier 20. In some embodiments, first surface 22 is a top surface of carrier 20 and second surface 24 is a bottom surface of carrier 20 such that first and second surfaces 22, 24 are disposed on opposite sides of carrier 20. As shown in FIG. 1, holes 30 form a continuous and open pathway from first surface 22 to second surface 24 of carrier 20. In some embodiments, as discussed further below, holes 30 provide a positive and/or negative air pressure through the holes.

Although FIG. 1 only shows six holes 30 for illustration purposes, it is contemplated that carrier 20 may comprise about 100 to about 20,000 holes, or about 500 to about 10,000 holes, or about 1,000 to about 5,000 holes. The number of holes depends, for example, on the size of carrier 20, the substrate to be processed (e.g. flexibility, elasticity, thickness, etc. of the substrate), and processing parameters (e.g. shape of cutting line/contour line of a laser beam). Furthermore, holes 30 may have any cross-sectional shape (along a longitudinal length of carrier 20) as is known in the art. In some embodiments, holes 30 have a circular cross-sectional shape. Adjacent holes 30 are spaced from each other a distance d, as shown in FIG. 1, such that distance d is the minimal spacing between the holes. Distance d is within the range of about 2 mm to about 100 mm, or about 5 mm to about 80 mm, or about 8 mm to about 60 mm, or about 20 mm to about 50 mm, or about 10 mm to about 30 mm, or about 12 mm, or about 15 mm. Distance d can depend on different parameters such as the material of the substrate to be processed, the thickness of the substrate, and processing parameters (e.g. shape of cutting line/contour line of a laser beam).

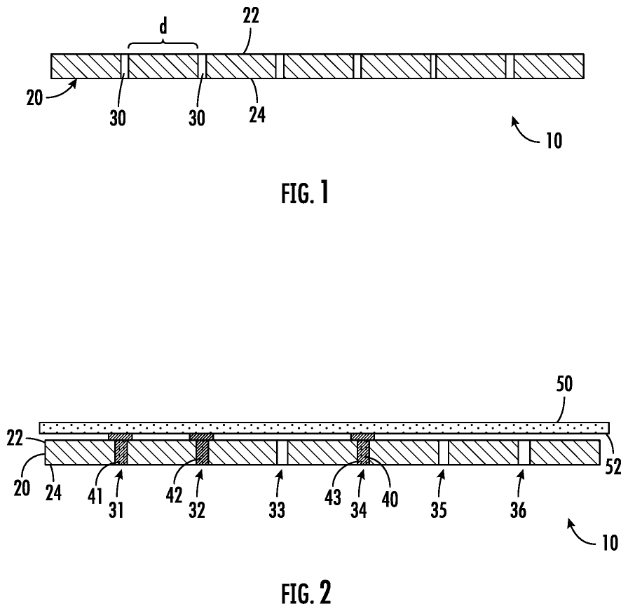

As shown in FIG. 2, transport apparatus 10 further comprises one or more bearing devices 40, each disposed within a hole 30. More specifically, in the illustrated embodiment of FIG. 2, carrier 20 comprises exemplary holes 31-36. In some embodiments, exemplary holes 31-36 are each a vacuum hole that provides a negative pressure so that carrier 20 comprises a first vacuum hole 31, a second vacuum hole 32, a third vacuum hole 33, a fourth vacuum hole 34, a fifth vacuum hole 35, and a sixth vacuum hole 36. However, it is also contemplated that one or more exemplary holes 31-36 may provide a positive air pressure outward, such as an air bearing. Additionally, in some embodiments, one or more exemplary holes 36 may be configured to selectively switch between applying the negative and positive air pressures. As also shown in FIG. 2, a first exemplary bearing device 41 is disposed within first vacuum hole 31, a second exemplary bearing device 42 is disposed within second vacuum hole 32, and a third exemplary bearing device 43 is disposed within fourth vacuum hole 34. Thus, third and sixth vacuum holes 33, 36 are left open such that no bearing devices are disposed in these vacuum holes. Therefore, it is within the scope of the disclosure that some holes 30 remain open while other holes 30 receive a bearing device 40, as also discussed further below.

In the embodiment depicted in FIG. 2, each bearing device 40 protrudes outward from first surface 22 of carrier 20 and is configured to support a substrate 50 during processing of the substrate. For example, bearing devices 40 are configured to support substrate 50 during a cutting, surface finishing, perforating, ablating, or coating procedure of the substrate. Because the bearing devices 40 protrude outward from carrier 20 and create a gap between substrate 50 and carrier 20, they prevent (or at least reduce) any contact between substrate 50 and carrier 20 that may cause damage to the substrate. For example, in some embodiments, a surface 52 of substrate 50 is coated with one or more coating layers such that any contact of surface 52 with carrier 20 could scratch the coating layers. Thus, bearing devices 40 are able to securely hold substrate 50 on carrier 20 while preventing/reducing any scratching of the substrate. A further description of bearing devices 40 is provided below.

Substrate 50 may comprise a coated or uncoated glass, glass-ceramic, and/or ceramic material. Exemplary glass compositions include, for example, borosilicate glass, soda-lime glass, aluminosilicate glass, alkali aluminosilicate, alkaline earth aluminosilicate glass, alkaline earth boro-aluminosilicate glass, fused silica, or crystalline materials such as sapphire, silicon, gallium arsenide, or combinations thereof. In some embodiments, the glass may be ion-exchangeable, such that the glass composition can undergo ion-exchange for glass strengthening before or after processing the substrate. For example, the substrate may comprise ion exchanged and ion exchangeable glass, such as Corning® Gorilla® Glass available from Corning Incorporated of Corning, N.Y. (e.g., code 2318, code 2319, and code 2320). Further, the glass may have coefficients of thermal expansion (CTE) of from about 6 ppm/° C. to about 10 ppm/° C. Other exemplary glasses include EAGLE XG® and CORNING LOTUS™ Glass available from Corning Incorporated of Corning, N.Y. In other embodiments, substrate 50 comprises glass ceramics or crystals such as sapphire or zinc selenide. It is also contemplated in other embodiment that substrate 50 comprises a polymeric material (coated or uncoated), such as a transparent plastic material. Furthermore, substrate 50 may comprise a metal or metal alloy (coated or uncoated).

In some embodiments, substrate 50 has a length ranging from about 50 mm to about 3,370 mm and a width ranging from about 50 mm to about 2,940 mm.

Although FIG. 2 only depicts one substrate 50, it is also contemplated that carrier 20 and bearing devices 40, as disclosed in the various embodiments herein, may be used with a plurality of stacked substrates. As is known in the art, the plurality of stacked substrates may comprise one or more intervening layers to reduce any scratching or chipping of the substrates.

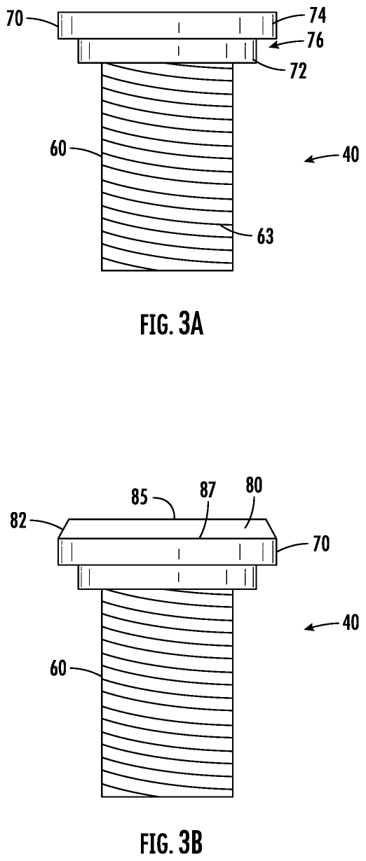

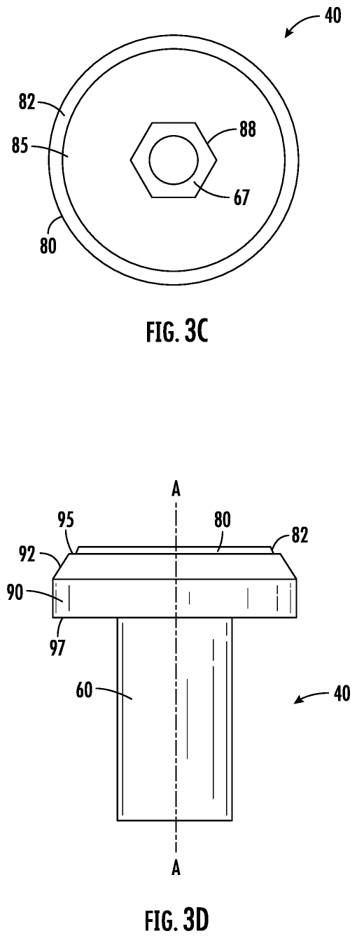

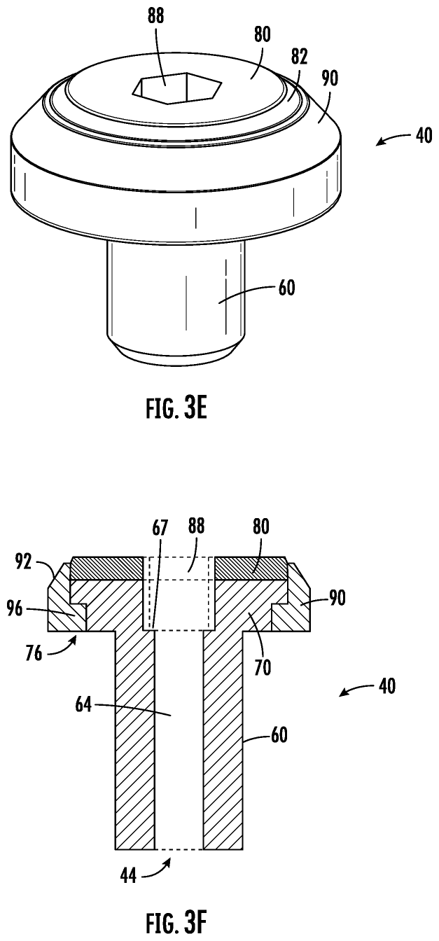

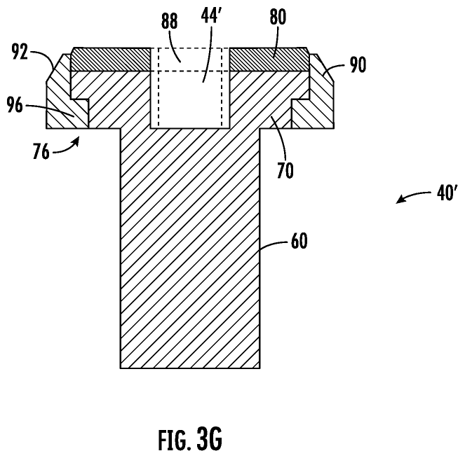

An enlarged view of an exemplary bearing device 40 is shown in FIG. 3A. In this embodiment, bearing device 40 comprises a shaft 60 and a head 70. As discussed further below and with reference to FIG. 3F, bearing device 40 may also comprise an internal opening. With further reference to FIG. 3A, an outer surface of shaft 60 includes a protruding thread 63 that extends radially outward from an outer surface of shaft 60. As discussed further below, thread 63 is configured to engage with an internal thread of holes 30 of carrier 20 to secure bearing device 40 within the holes 30. It is also contemplated, in other embodiments, that the outer surface of shaft 60 does not include thread 63 and, instead, has a flat outer surface. In yet other embodiments, shaft 60 includes, rather than thread 63, hooks, press fittings, or projections on its outer surface to counterforce an upward movement of the bearing device 40 out of the hole. As discussed further below, in some embodiments in which shaft 60 does not comprise thread 63, holes 30 do not comprise an internal thread.

In some embodiments, shaft 60 has a circular outer perimeter so that it can securely and easily fit within the circular holes 30. However, it is also contemplated that shaft 60 may comprise other shapes depending on the shape and structure of holes 30.

As shown in FIG. 3A, head 70 extends radially outward of shaft 60 so that an outer diameter of head 70 is larger than an outer diameter of shaft 60. Furthermore, head 70 comprises a first portion 72 and a second portion 74, such that second portion 74 extends radially outward of first portion 72 and forms indentation 76. Therefore, an outer diameter of second portion 74 is larger than an outer diameter of first portion 72. The transition from first portion 72 to second portion 74 may have a step profile, as shown in 3A. However, it is also contemplated that the transition from first portion 72 to second portion 74 is rounded.

First portion 72 and second portion 74 may be one integral member or may be formed of one or more different units connected together. Furthermore, head 70 and shaft 60 may be one integral member or may be formed of one or more different units connected together.

Shaft 60 may have a length ranging from about 3 mm to about 15 mm, or about 5 mm to about 10 mm, or about 6 mm to about 8 mm. First portion 72 and second portion 74 of head 70 may each have a length ranging from about 0.5 mm to about 2 mm. In some embodiments, first portion 72 and second portion 74 are both about 1 mm. However, it is also contemplated that first portion 72 and second portion 74 have different lengths. In some embodiments, first portion 72 is circular and has an outer diameter ranging from about 5 mm to about 10 mm, or about 6 mm to about 9 mm, or about 7.5 mm to about 8 mm. In some embodiments, second portion 74 is circular and has an outer diameter ranging from about 7 mm to about 15 mm, or about 8 mm to about 12 mm, or about 9 mm to about 10 mm.

With reference to FIG. 3B, in some embodiments, bearing device 40 further comprises a cover 80 disposed on a top surface of head 70. Cover 80 has a top surface 85 and a bottom surface 87 connected by a chamfered surface 82. However, it is also contemplated that surface 82 can have other edge profiles and shapes. In some embodiments, chamfered surface 82 has a slope of about 45 degrees relative to bottom surface 87. Cover 80 provides a smooth outer covering for shaft 60 and head 70, thus allowing a substrate 50 to be glidingly positioned on bearing device 40 without scratching or otherwise damaging the substrate. Furthermore, cover 80 protects shaft 60 and head 70 during cleaning of carrier 20.

As shown in FIG. 3C, top surface 85 of cover 80 comprises an aperture 88. In the embodiment of FIG. 3C, aperture 88 has a hexagonal shape (as also shown in FIG. 3E) for engagement with a fastening member, such as a screwdriver or power drill. For example, the hexagonal shape of aperture 88 mates with the tip of the screwdriver or drill for installment into hole 30 or removal of the bearing device 40 out of the hole 30.

Aperture 88 may extend for the entire length of cover 80 (from top surface 85 to bottom surface 87). Furthermore, aperture 88 may align with the internal opening through shaft 60 (as discussed further below with reference to FIG. 3F), thus creating a single cavity. In some embodiments, cover 80 and aperture 88 both have a length ranging from about 1 mm to about 5 mm, or about 1.5 mm to about 4 mm, or about 2 mm to about 3 mm. Cover 80 may be circular and have a maximum outer diameter equal to the maximum outer diameter of second portion 74 of head 70. The maximum outer diameter of cover 80 may range from about 7 mm to about 15 mm, or about 8 mm to about 12 mm, or about 9 mm to about 10 mm.

As shown in the top view of FIG. 3C, the width of aperture 88 is greater than at least a part of the internal opening through shaft 60. Therefore, from the top view of cover 80 (as shown in FIG. 3C), internal top wall surface 67 of shaft 60 is visible through aperture 88 (as also shown in FIG. 3E).

However, it is also contemplated in other embodiments that top surface 85 of cover 80 does not include aperture 88 and, instead, forms a barricade that closes the internal opening of shaft 60 and head 70. In these embodiments, cover 80 forms a seal with head 70 and top surface 85 does not comprise any openings. These embodiments may be used when shaft 60 does not comprise thread 63, therefore shaft 60 does not need to be screwed into engagement with the internal thread of holes 30.

In some embodiments, bearing device 40 comprises a collar 90 disposed radially outward of cover 80 and head 70. As shown in FIGS. 3D-3G, collar 90 comprises an annular, ring-shaped member that encircles both cover 80 and head 70. A top surface 95 of collar 90 is connected to a bottom surface 97 of collar 90 with a chamfered surface 92. In some embodiments, chamfered surface 92 has a slope of about 50 degrees relative to bottom surface 97. However, it is also contemplated that chamfered surface 92 can have other edge profiles and shapes such as, for example, a rounded chamfered surface or a surface having an offset chamfered shape. As discussed further below, the chamfered surface 92 of collar 90 and the chamfered surface 82 of cover 80 help to prevent/reduce any scratching or damage to a substrate by providing smooth and gentle surfaces onto which substrate 50 can easily slide and glide during, for example, loading and unloading procedures.

In some embodiments, collar 90 has a length (from top surface 95 to bottom surface 97) ranging from about 2 mm to about 7 mm, or about 2.5 mm to about 5 mm, or about 3.5 mm to about 4 mm. Collar 90 may be circular and have a maximum outer diameter ranging from about 8 mm to about 20 mm, or about 12 mm to about 16 mm.

As further shown in FIGS. 3F and 3G, a lower portion of collar 90 forms a protrusion 96 that protrudes radially inward toward a center axis of bearing device 40. Protrusion 96 is configured to mate with indentation 76 of head 70 to secure collar 90 on bearing device 40. In some embodiments, protrusion 96 and indentation 76 form an interference fit to secure these components together. The positioning of collar 90 around cover 80 and head 70 also helps to secure cover 80 and head 70 on bearing device 40 and within hole 30.

Collar 90, cover 80, shaft 60, and head 70 may all be comprised of the same or different materials. In some embodiments, collar 90, shaft 60, and head 70 are each comprised of a metal or metal alloy. Exemplary materials for collar 90, shaft 60, and head 70 include, for example, iron (Fe), titanium (Ti), tin (Sn), copper (Cu), magnesium (Mg), indium (In), chromium (Cr), molybdenum (Mo), aluminum (Al), niobium (Nb), tantalum (Ta), vanadium (Va), zinc (Zn), silver (Ag), nickel (Ni), gold (Au), platinum (Pt), palladium (Pd), and combinations thereof. In some embodiments, collar 90, shaft 60, and head 70 are each formed of stainless steel. However, it is also contemplated that at least one of collar 90, shaft 60, and head 70 is comprised of a different material from one or more of these other components. For example, in some embodiments, collar 90 may be comprised of a polymeric material (such as those disclosed below with reference to cover 80) while shaft 60 and head 70 are formed of a metal material. The material of shaft 60 and head 70 should be durable so that it is not damaged by the laser processing of substrate 50.

Furthermore, cover 80 may be comprised of a polymeric material. Exemplary materials for cover 80 include, for example, polypropylene, polyethylene terephthalate (PET), low-density polyethylene (LDPE), high-density polyethylene (HDPE), polyacetals, polycarbonates, polyesters, polysulfones, polyetherimides, polyetherketones, acrylonitrile butadiene styrene (ABS), poly(phenylene sulfide), nylons, elastomers, nitrile butadiene rubber (NBR), and combinations thereof. The material of cover 80 should be flexible and, in some embodiments, elastic so that it does not damage or scratch substrate 50. The polymeric material of cover 80 may also function as a damper that dampens any vibrations due to movement of substrate 50. In some embodiments, cover 80 is comprised of a first material that is polymeric and collar 90, shaft 60, and head 70 are all comprised of the same second material that is a metal material.

Collar 90 and/or cover 80 may also include an outer coating, such as a friction reducing coating or an oxidation reduction coating. Additionally or alternatively, collar 90 and/or cover 80 may include an outer coating configured to reduce reflection of the laser beam. It is also contemplated that an inner coating or layer is disposed between collar 90 and cover 80 to reduce any sliding movement between these components. For example, the inner layer may be a rubber layer. The inner coating or layer between collar 90 and cover 80 may, additionally or alternatively, be an adhering coating or layer that promotes adhesion between these components.

It is noted that FIGS. 3D and 3E depict embodiments in which shaft 60 does not include any external threads. In these embodiments, the outer surface of shaft 60 is flat and smooth.

FIG. 3F depicts a cross-sectional view of bearing device 40 along line A-A of FIG. 3D. As shown in FIG. 3F, shaft 60 and head 70 comprise an internal opening 64 that extends for an entire length of shaft 60 and head 70. Internal opening 64 aligns with aperture 88 of cover 80 to create a unitary and single cavity 44 through bearing device 40. Cavity 44 extends from a top surface to a bottom surface of bearing device 40. In some embodiments, cavity 44 has a first width (e.g., diameter) through shaft 60 and a second width (e.g., diameter) through head 70 such that the second width is larger than the first width. The first width of cavity 44 may range from about 0.5 mm to about 3 mm, or about 1 mm to about 2.5 mm, or about 1.5 mm to about 2 mm. The second width of cavity 44 may be equal to an inner width (e.g., diameter) of aperture 85 and may range from about 2 mm to about 10 mm, or about 4 mm to about 8 mm. In the embodiment of FIG. 3F, cavity 44 comprises a hexagonal cross-sectional shape. However, it is also contemplated that cavity may comprise other cross-sectional shapes such as, for example, triangular, circular, rectangular, or pentagonal. Although FIG. 3F depicts an embodiment in which bearing device 40 comprises both cover 80 and collar 90, it also contemplated that the features disclosed with regard to FIG. 3F pertain to the other embodiments of the disclosure, such as those in which bearing device 40 does not include cover 80 and/or collar 90.

FIG. 3G depicts a cross-sectional view of another embodiment of bearing device 40′ along line A-A of FIG. 3D. The bearing device 40′ of FIG. 3G comprises shaft 60, head 70, cover 80, and collar 90, as discussed above. However, the bearing device 40′ of FIG. 3G has an internal cavity 44′ that only extends through head 70 and does not extend through shaft 60. In this embodiment, cavity 44′ aligns with aperture 88, as also discussed above. Because cavity 44′ does not extend through shaft 60, bearing device 40 is a solid device that does not provide a vacuum or air bearing feature. Bearing device 40′ may be used in locations on carrier 20 to hold and support substrate 50 but where a suction or air bearing feature is not needed or required. Although FIG. 3G depicts an embodiment in which bearing device 40′ comprises both cover 80 and collar 90, it also contemplated that the features disclosed with regard to FIG. 3G pertain to the other embodiments of the disclosure, such as those in which bearing device 40′ does not include cover 80 and/or collar 90.

It is also contemplated, in other embodiments, that bearing device 40′ does not comprise any internal cavity 44/44′ and instead comprises a solid device. Therefore, in these embodiments, neither shaft 60 nor head 70 comprises an internal opening. In these embodiments, cover 80 may also not comprise aperture 88.

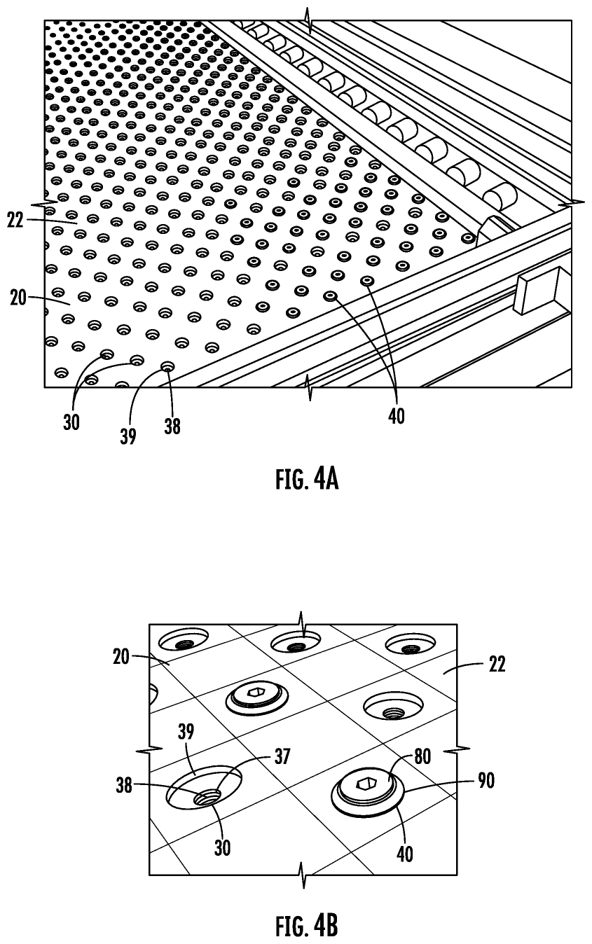

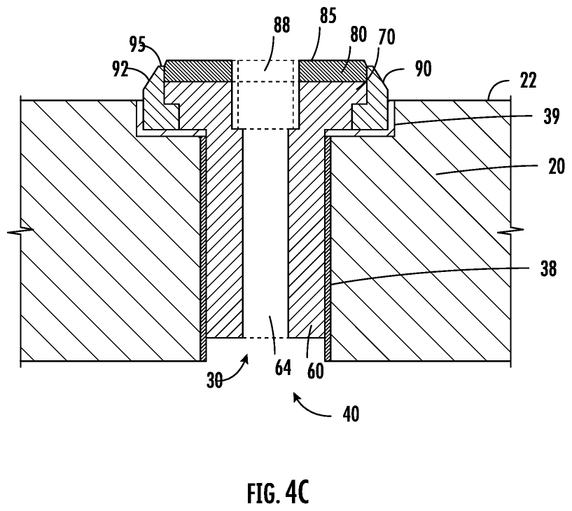

FIG. 4A depicts an exemplary carrier 20 with a plurality of holes 30 during a process of installing bearing devices 40 in the holes, and FIG. 4B depicts an enlarged view of a portion of FIG. 4A. As discussed further below, it is within the scope of the disclosure that, when installing bearing devices 40 in holes 30, some of the holes may remain open and will not receive a bearing device.

In the embodiment of FIGS. 4A and 4B, holes 30 are comprised of a primary hole 38 and a secondary hole 39. As shown in FIGS. 4A and 4B, secondary hole 39 is wider but shorter in length than primary hole 38. Thus, in embodiments where holes 30 are circular in cross-section, primary hole 38 has a smaller diameter than secondary hole 39. Primary hole 38 is configured to receive shaft 60, and secondary hole 39 is configured to receive head 70 and collar 90.

FIG. 4C depicts a cross-sectional view of carrier 20 with an exemplary bearing device 40 disposed in a hole 30. As shown in FIG. 4C, shaft 60 is disposed in primary hole 38 of hole 30, and head 70 and collar 90 are disposed in secondary hole 39 of hole 30. However, collar 90 is only partly disposed in secondary hole 39 so that chamfered surface 92 extends above and outward from first surface 22 of carrier 20. When bearing device 40 is fully positioned or disposed in hole 30, as shown in FIG. 4C, collar 90 and cover 80 fully enclose head 70. It is also noted that bearing device 40 may extend for the full length of hole 30, less than the full length of hole 30, or longer than the full length of hole 30. In the embodiment of FIG. 4C, bearing device 40 is shorter in length than hole 30. Although not shown in FIG. 4C, cover 80 directly contacts a substrate 50 positioned on carrier 20.

Primary holes 38, in some embodiments and as shown in FIG. 4B, comprise an internal thread 37 configured to mate with thread 63 of shaft 60. Therefore, shaft 60 is screwed into holes 30 for a secure connection between these components. However, it is also contemplated that, in some embodiments, primary holes 38 do not include an internal thread. In these embodiments, shaft 60 does not comprise an external thread and is secured within holes 30 with, for example, a press fit or interference fit connection. Regardless of the connection between shaft 60 and holes 30, the connection is removable so that bearing devices 40 can be easily positioned within and removed from holes 30.

When bearing device 40 is fully disposed within hole 30, a top surface of head 70 protrudes above and outward from first surface 22 of carrier, as shown in FIG. 4C. However, it is also contemplated that the top surface of head 70 is flush and substantially planar with first surface 22 of carrier 20. Regardless, top surface 85 of cover 80 and top surface 95 of collar 90 protrude above and radially outward from first surface 22 of carrier 20, as shown in FIGS. 4B and 4C. The protrusion between head 70, cover 80, and/or collar 90 with surface 22 of carrier 20 provides a gap between a substrate 50 disposed on the bearing device 40 and first surface 22 of carrier 20, as shown in FIG. 2. This gap may have a length from about 1 mm to about 7 mm, or about 2 mm to about 5 mm, or about 3 mm to about 4 mm. It is noted that the length of the gap is equal to the distance from top surface 85 of cover 80 to first surface 22 of carrier 20 when bearing device 40 is fully inserted within hole 30 (and in embodiments in which the bearing device includes a cover). In some embodiments, the gap is equal to the length of cover 80. As discussed above, this gap provides a clearance between substrate 50 and carrier 20, thus reducing/preventing any contact between these components. This advantageously reduces any scratching or damage to substrate 50.

Bearing devices 40 are disposed in a sufficient number of holes 30 to prevent warp of substrate 50. A computer can assist in the placement of bearing devices 40 to ensure that an optimum layout of bearing devices 40 is achieved to prevent warp of substrate 50. It is noted that this optimum layout may include some holes 30 that are open and that do not receive a bearing device 40. The computer can also calculate an optimum amount of suction force for each hole 30 to prevent any such warp of substrate 50.

As discussed above, shaft 60 and head 70 are formed of a metal or metal alloy, while cover 80 is formed of a polymeric material. When a substrate 50 is positioned on carrier 20 and subjected to, for example, a laser perforation or ablation process, the durable materials of shaft 60 and head 70 are not damaged by the laser. However, the materials of shaft 60 and head 70 can potentially scratch substrate 50. The flexible and/or elastic materials of cover 80 prevent such scratching by covering head 70 and, thus, preventing contact between substrate 50 and the abrasive materials of shaft 60 and head 70. However, the materials of cover 80 are not as durable and can be damaged by the laser during the perforation or ablation process. It is also noted that although collar 90 is comprised of the same material as shaft 60 and head 70 in some embodiments, collar 90 comprises chamfered surface 92 so that it does not scratch substrate 50.

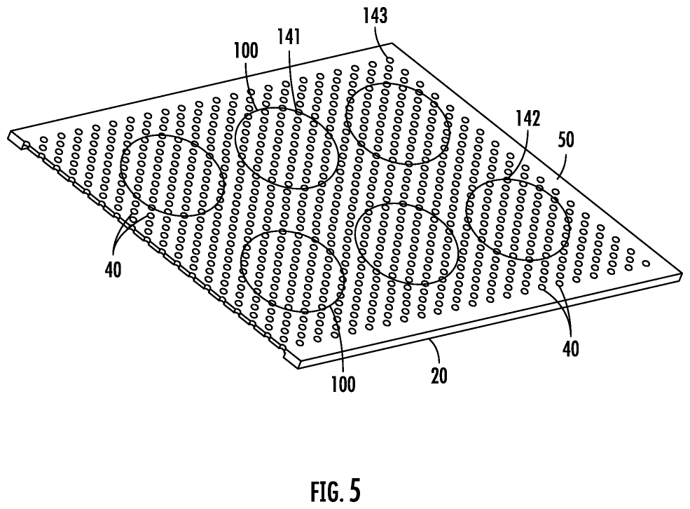

With reference to FIG. 5, a substrate 50 is positioned on carrier 20 and ready for a perforation or ablation process. Bearing devices 40 are disposed in carrier 20 to support substrate 50 during the process. Cutting pathways 100 are depicted on substrate 50 (for illustration purposes) to show where substrate 50 will be cut with a laser. As discussed above, the laser could damage the polymeric material of cover 80 on bearing devices 40 that are disposed along pathway 100. Therefore, these bearing devices 40 are either removed or replaced with other bearing devices 40 (which do not have a cover 80) so as not to damage the polymeric material. During the laser perforation or ablation process, the laser beam would not only damage the material of cover 80, but the laser beam could also be reflected from the material of cover 80 and cause chipping of substrate 50.

More specifically, embodiments of the present disclosure include (i) only placing bearing devices 40 that include a cover 80 in holes 30 that are not disposed along a cutting pathway 100, (ii) removing bearing devices 40 that include a cover 80 from holes 30 disposed along a cutting pathway 100, (iii) placing bearing devices 40 that do not include a cover 80 in holes 30 disposed along a cutting pathway 100, and/or (iv) leaving holes 30 disposed along a cutting pathway 100 open so that they do not include a bearing device 40. It is noted that the bearing devices referenced in (i) through (iv) may each (a) include a collar 90 or not include a collar 90, (b) comprise an internal opening extending through both shaft 60 and head 70, (c) comprise an internal opening that only extends through head 70 but not through shaft 60, or (d) not comprise an internal opening through either shaft 60 or head 70.

In the exemplary embodiment of FIG. 5, the holes of bearing devices 141 and 142 are disposed along cutting pathway 100. Therefore, only bearing devices without a polymeric cover 80 should be disposed in these holes. Bearing devices 141 and 142 should still comprise a shaft 60 and a head 70. Alternatively, bearing device 141 and/or bearing device 142 could be removed so that its hole is left open. As also shown in FIG. 5, bearing device 143 is not disposed along cutting pathway 100. Therefore, bearing device 143 may be a bearing device with a cover 80 since it will not be damaged by the laser during the cutting procedure.

Bearing devices 141, 142, 143 may have the same or different shaft 60 and head 70 structures and shapes, as discussed above. For example, one or more of bearing devices 141,142, 143 may include or not include internal opening 64 through its shaft 60 and/or head 70. In one exemplary embodiment, bearing device 143 is a first bearing device disposed in a first hole 30 and comprises a first shaft, a first head, and an internal opening 64 extending through an entire length of the first shaft and the first head. In this embodiment, bearing device 141 is a second bearing device disposed in a second hole and comprises a second shaft and a second head. However, in this embodiment, the second bearing device does not comprise an internal opening 64 through at least the second shaft. The second bearing device may or may not still comprise an internal opening 64 through the second head. It is also noted that the second hole may alternatively be an open hole such that the second bearing device is not disposed in the second hole.

Cutting pathways 100 may have other shapes and sizes than depicted in FIG. 5 and the exemplary cutting pathways 100 depicted in FIG. 5 are not intended to limit the scope of the disclosure. For example, a plurality of cutting pathways with different shapes and sizes may be applied on a single substrate.

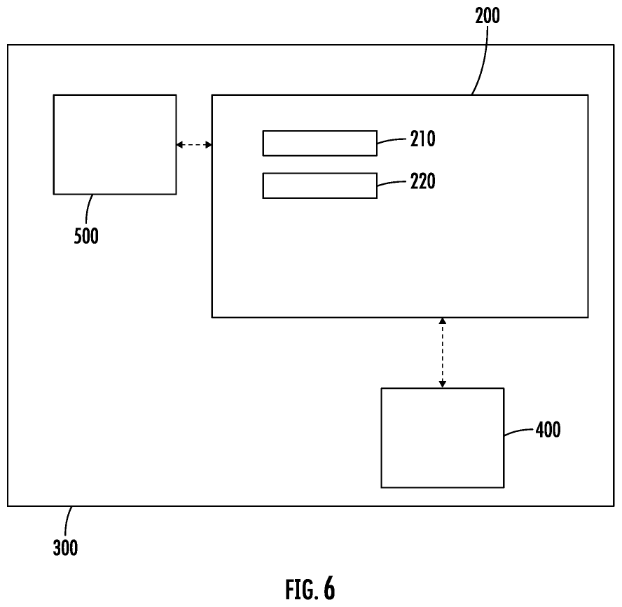

In some embodiments, a processing unit determines which holes 30 should receive a bearing device 40, what bearing device 40 should be disposed within those holes, and which holes should be left open. FIG. 6 depicts a schematic representation of a substrate processing apparatus 300 comprising a processing unit 200, a laser processing tool 500, and a user interface 400. Although FIG. 6 depicts processing apparatus 300 as encompassing processing unit 200, laser processing tool 500, and user interface 400, it is also contemplated in other embodiments that one or more of processing unit 200, laser processing tool 500, and user interface 400 are part of a different system. Processing unit 200 comprises a processor 210 and a memory 220. As is known in the art, memory 220 stores a processor executable program comprising one or more functions and/or routines configured to be executed by processor 210. And, processor 210 comprises a central processing unit (CPU) configured to execute the functions and/or routines. Processing unit 200 is in communication with laser processing tool 500 and user interface 400 over a network (not shown) via, for example, a wireless communication network.

Laser processing tool 500 may be, for example, a laser cutting system configured to perforate, cut, and/or ablate substrate 50 along a cutting pathway 100 (as shown for example in FIG. 5). However, it is also contemplated, in other embodiments, that tool 500 provides a surface finishing or coating process to substrate 50. Processor 210 may receive substrate cutting information from laser processing tool 500 such that the substrate cutting information includes one or more cutting pathways 100 for cutting substrate 50 along one or more predetermined patterns. Based upon the received substrate cutting information, processor 210 determines which holes 30 on carrier 20 are disposed along cutting pathway 100 of the predetermined pattern(s). Processor 210 may flag these holes because they are located along cutting pathway 100. More specifically, processor 210 may designate one or more of these holes as not receiving a bearing device 40 or may designate one or more of these holes as receiving a bearing device 40 that does not include a cover 80. Therefore, during the perforation or ablation process, the laser will not damage any bearing devices disposed along cutting pathway 100.

Based upon the received substrate cutting information, processor 210 also determines which holes 30 on carrier 20 are not disposed along the cutting pathways 100 of the predetermined pattern(s). Processor 210 may designate one or more of these holes as receiving a bearing device 40. However, as discussed above, not all holes 30 that are disposed outside of pathways 100 receive a bearing device 40. Instead, some holes 30 may remain open to, for example, provide a suction force through these holes for the removal of ablated material. Other holes 30 that are disposed outside of pathways 100 may remain open to reduce the assembly time of inserting numerous bearing devices 40 within the holes 30.

Processor 210 determines which holes 30 disposed outside of pathways 100 should receive a bearing device 40 (and which kind of bearing device 40) and which holes 30 should be left open (i.e., so that they do not receive a bearing device 40). When making such a determination, processor 210 takes into account the minimum number of holes 30 needed to be filled with a bearing device 40 in order to prevent any warp of substrate 50. Such a determination may be based, at least in part, on the size of substrate 50 and/or the material of substrate 50. If a certain number of holes 30 are not left open, without a bearing device 40, such may cause substrate 50 to warp and flex downward, toward carrier 20, causing damage of the substrate 50.

Additionally, in some embodiments, processor 210 determines the pressure (whether positive or negative) flowing through each hole 30. For example, processor 210 determines the suction force of each hole 30. In some embodiments, one or more holes 30 have a different pressure force than one or more other holes 30. It is also contemplated that one or more holes 30 have a positive pressure while one or more other holes have a negative pressure.

After determining the layout of bearing devices 40 on carrier 20, based upon cutting pathways 100, processor 210 sends template information to user interface 400. Based upon the received template information, user interface 400 identifies to a user which holes 30 should receive a bearing device 40 (and what kind of bearing device 40). User interface 400 is a device configured to instruct or demonstrate to a user the pattern of bearing devices 40 on carrier 20. In some embodiments, user interface 400 is configured to visually and/or orally provide such instruction or demonstration. Exemplary user interfaces 400 include, for example, a monitor, a printer, or a handheld device such as a smartphone or tablet. In other embodiments, user interface 400 is a projection system configured to highlight one or more holes 30 on carrier 20. For example, user interface 400 may be a projection system that highlights holes 30 in green that are designated as receiving a bearing device 40 with a cover 80, highlights holes 30 in blue that are designated as receiving a bearing device 40 without a cover 80, and/or highlights holes 30 in red that are designated as being open holes. It is further contemplated that the projection system highlights holes 30 in dark green that are designated as receiving a bearing device 40 with a cover 80 but without an internal opening 64 and highlights holes 30 in light green that are designated as receiving a bearing device 40 with a cover 80 and with an internal opening 64. In other embodiments, the projection system highlights specific holes with a laser beam or with an LED device, such as the holes that are designated as being open holes.

In some embodiments, carrier 20 may comprise a grid system so that a user can easily identify the specific holes 30 on carrier 20 when placing the bearing devices in the holes. For example, the X-axis of carrier 20 is labeled with numbers (e.g., 1 through 1,000) and the Y-axis of carrier 20 is labeled with letters (e.g., A through Z). Therefore, user interface 400 may designate holes 30 located at positions (20, C) and (524, M) as being open holes. A user can easily identify these specific holes on carrier 20 with the grid pattern.

It is also contemplated that a scanning unit scans the positioning of bearing devices 40 on carrier 20 to ensure that they are positioned correctly. This may be used as a check to verify that bearing devices 40 were installed properly and in the correct locations. The scanning unit comprises a camera system and/or a sensing system to determine the positioning of bearing devices 40 on carrier 20.

By allowing bearing devices 40 to be easily removed and relocated along carrier 20, such provides flexibility in the layout of bearing devices 40 on carrier 20. Therefore, the pattern of bearing devices 40 is able to be customized for an individual cutting pattern in an efficient and time saving manner. Additionally, bearing devices 40 securely support a substrate during processing of the substrate while advantageously preventing scratching of the substrate.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary embodiments, but should be defined only in accordance with the following claims and their equivalents.

What is claimed is:

1. A substrate transporting apparatus comprising:
a carrier comprising a first surface and a second surface opposite the first surface, the carrier being configured to support a substrate to be processed;
a plurality of holes disposed within the carrier, each hole extending from the first surface to the second surface of the carrier, the plurality of holes comprising at least a first hole and a second hole; and
a first bearing device disposed in the first hole, the first bearing device comprising a first shaft, a first head, and an internal opening extending an entire length of the first shaft and the first head,
wherein the second hole either (i) is an open hole without a bearing device disposed therein, or (ii) comprises a second bearing device disposed therein, the second bearing device comprising a second shaft and a second head without an internal opening disposed through the second shaft.

2. The apparatus of claim 1, wherein the second hole is an open hole without a bearing device disposed therein.

3. The apparatus of claim 1, wherein the second hole comprises the second bearing device disposed therein.

4. The apparatus of claim 1, wherein the first hole is a vacuum hole configured to apply a suction force to the substrate.

5. The apparatus of claim 1, wherein an outer diameter of the first head is greater than an outer diameter of the first shaft.

6. The apparatus of claim 1, wherein an outer surface of the first shaft comprises external threads.

7. The apparatus of claim 6, wherein the first hole comprises internal threads configured to mate with the external threads of the first shaft.

8. The apparatus of claim 1, wherein the first shaft and the first head are each comprised of a metal material.

9. The apparatus of claim 1, wherein the first bearing device further comprises a cover disposed on a top surface of the first head.

10. The apparatus of claim 9, wherein the cover is comprised of a polymeric material.

11. The apparatus of claim 9, wherein the cover comprises an aperture configured to align with the internal opening of the first shaft and the first head to create a continuous cavity.

12. The apparatus of claim 9, wherein, when the first bearing device is disposed in the first hole, a top surface of the cover extends a distance of about 2 mm to about 5 mm from the first surface of the carrier.

13. The apparatus of claim 9, wherein the first bearing device further comprises a collar disposed around an outer perimeter of the first head.

14. The apparatus of claim 13, wherein the collar comprises an outer chamfered surface.

15. The apparatus of claim 13, wherein the collar comprises a protrusion that extends inwards, towards a center axis of the first bearing device, the protrusion being configured to mate with an indentation in the first head.

16. The apparatus of claim 13, wherein the collar is comprised of a metal material.

17. The apparatus of claim 13, wherein, when the first bearing device is disposed in the first hole, the collar extends outward of the first hole.

18. The apparatus of claim 1, wherein the plurality of holes are each spaced a distance of about 5 mm to about 20 mm from adjacent holes.

19. The apparatus of claim 1, further comprising a processing unit configured to determine a template for inserting bearing devices in the plurality of holes, the template based upon a cutting pathway of the substrate.

20. The apparatus of claim 19, further comprising a user interface configured to identify for a user which holes of the plurality of holes are designated as receiving a bearing device and which holes of the plurality of holes are designated as not receiving a bearing device.
